(19) United States
(12) Patent Application Publication
(10) Pub. No.: US 2026/0211147 A1
(43) Pub. Date: Jul. 23, 2026

(54) MULTIPLE PIPES DEFORMATION DETECTION USING ELECTROMAGNETIC TECHNIQUES

(71) Applicant: Halliburton Energy Services, Inc., Houston, TX (US)

(72) Inventors: Huiwen Sheng, Singapore (SG); Ahmed Fouda, Houston, TX (US)

(73) Assignee: Halliburton Energy Services, Inc., Houston, TX (US)

(21) Appl. No.: 19/033,849

(22) Filed: Jan. 22, 2025

(51) Int. Cl. G01V 3/28

(52) U.S. Cl. CPC G01V 3/28

(57) ABSTRACT

Methods and systems disclosed herein may comprise disposing an electromagnetic (EM) logging tool in a wellbore, wherein the EM logging tool comprises: one or more transmitters disposed on the EM logging tool; and one or more receivers disposed on the EM logging tool. Methods and systems may also be configured for transmitting a first EM field from the one or more transmitters into two or more nested pipes to energize the two or more nested pipes with the first EM field thereby producing an eddy current in the one or more nested pipes; measuring a second EM field generated by the eddy current in the two or more nested pipes with the one or more receivers to form a plurality of measurements Moreover, methods and systems may comprise determining the structural irregular zone type and severity qualitatively with magnitude and orientation of the EM log distortion.

### BACKGROUND

For oil and gas exploration and production, downhole pipes such as a network of wells, installations and other conduits may be established by connecting sections of metal pipe together. For example, a well installation may be completed, in part, by lowering multiple sections of metal pipe (e.g., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

Downhole pipes are subjected to extreme conditions, including high pressures, high temperatures, and corrosive environments. Deformations, or structural irregular zones, such as buckling, dents, collapses, or ridges may compromise the structural integrity of the pipe. If left undetected, these deformations may lead to serious issues such as leaks, bursts, or even a complete well collapse, posing significant safety hazards to personnel and the environment. Detecting deformations early helps in planning maintenance, avoiding sudden failures that require unplanned interventions. Unplanned downtime due to pipe deformation is costly, with potential production loss and repair expenses. It is especially challenging to detect deformations, or structural irregular zones, in multiple tubular pipes. The condition and environment are more complex. Pipes may experience different types of structural irregular zones, and it adds more difficulty to detect and quantify each type of structural irregular zones on different pipes.

### BRIEF DESCRIPTION OF THE DRAWINGS

These drawings illustrate certain aspects of some examples of the present disclosure and should not be used to limit or define the disclosure.

FIG. 1 illustrates an operating environment for an Electromagnetic (EM) logging tool;

FIG. 2 the EM tool in a pipe string;

FIG. 3 illustrates an example information handling system;

FIG. 4 illustrates another example information handling system;

FIG. 5 illustrates an example of one arrangement of resources in a computing network;

FIG. 6A illustrates an electromagnetic inspection and detection of anomalies;

FIG. 6B illustrates an electromagnetic inspection and detection of anomalies deeper along the z axis in reference to FIG. 6A;

FIG. 6C illustrates an electromagnetic inspection and detection of anomalies deeper along the z axis in reference to FIG. 6B;

FIG. 6D illustrates an electromagnetic inspection and detection of anomalies deeper along the z axis in reference to FIG. 6C;

FIG. 6E illustrates an electromagnetic inspection and detection of anomalies deeper than FIG. 6D;

FIG. 7 illustrates an example of a multiple tubular well plan;

FIG. 8A illustrates an example of electromagnetic log data;

FIG. 8B illustrates EM log data with an overlap in eccentricity zones;

FIG. 9 illustrates electromagnetic log data plotted as a spectrum;

FIG. 10A illustrates a configuration of a first example;

FIG. 10B illustrates another configuration of a first example;

FIG. 10C illustrates the acquired electromagnetic log data for four receivers;

FIG. 11A illustrates a configuration of a second example;

FIG. 11B illustrates another configuration of a second example;

FIG. 11C illustrates the acquired electromagnetic log data for four receivers;

FIG. 12A illustrates a configuration of a third example;

FIG. 12B illustrates another configuration of a third example;

FIG. 12C illustrates the acquired electromagnetic log data for four receivers;

FIG. 13A illustrates a configuration of a fourth example;

FIG. 13B illustrates another configuration of a fourth example;

FIG. 13C illustrates the acquired electromagnetic log data for four receivers;

### DETAILED DESCRIPTION

This disclosure is directed to methods and systems for subterranean operations and, more particularly, to detect structural irregular zones in a downhole well with at least two nested well tubulars using electromagnetic log data. The electromagnetic data contains at least one receiver's data at multiple frequencies, or multiple receivers' data at a single frequency, or multiple receivers' data at multiple frequencies. Depth alignment may be applied to multiple receivers' data. Spectral analysis may be applied to the data to differentiate among eccentricity, deformation, and localized corrosion. An analysis may be performed using the magnitude and orientation of variation in the data. Magnitude and variation of data may then be used to qualitatively determine the structural irregular zone type and severity. Radial one dimensional inversion (R1D) or data mapping or other signal processing method may be applied to the data to get a quantitative result of the structural irregular zone type and severity.

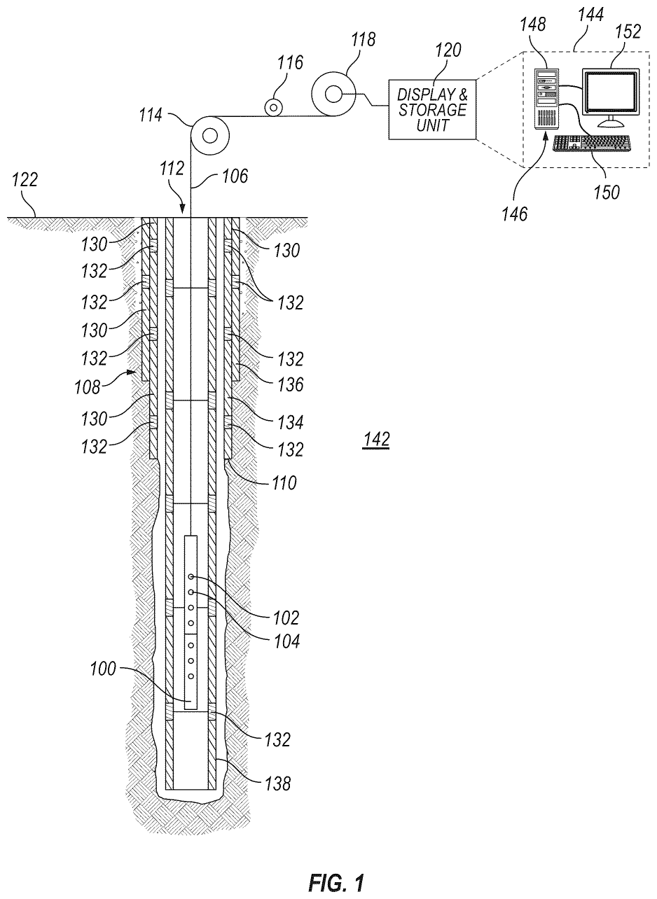

FIG. 1 illustrates an operating environment for an EM logging tool 100 as disclosed herein in accordance with some embodiments. EM logging tool 100 may comprise a transmitter 102 and/or a receiver 104. In examples, transmitters 102 and receivers 104 may be coil antennas. Furthermore, transmitter 102 and receiver 104 may be separated by a space between about 0.1 inches (0.254 cm) to about 200 inches (508 cm). In examples, EM logging tool 100 may be an induction tool that may operate with continuous wave execution of at least one frequency. This may be performed with any number of transmitters 102 and/or any number of receivers 104, which may be disposed on EM logging tool 100. In additional examples, transmitter 102 may function and/or operate as a receiver 104 or vice versa. EM logging tool 100 may be operatively coupled to a conveyance 106 (e.g., wireline, slickline, coiled tubing, pipe, downhole tractor, and/or the like) which may provide mechanical suspension, as well as electrical connectivity, for EM logging tool 100. Conveyance 106 and EM logging tool 100 may extend within casing string 108 to a desired depth within the wellbore 110. Conveyance 106, which may include one or more electrical conductors, may exit wellhead 112, may pass around pulley 114, may engage odometer 116, and may be reeled onto winch 118, which may be employed to raise and lower the tool assembly in wellbore 110.

Signals recorded by EM logging tool 100 may be stored on memory and then processed by display and storage unit 120 after recovery of EM logging tool 100 from wellbore 110. Alternatively, signals recorded by EM logging tool 100 may be conducted to display and storage unit 120 by way of conveyance 106. Display and storage unit 120 may process the signals, and the information contained therein may be displayed for an operator to observe and stored for future processing and reference. It should be noted that an operator may include an individual, group of individuals, or organization, such as a service company. Alternatively, signals may be processed downhole prior to receipt by display and storage unit 120 or both downhole and at surface 122, for example, by display and storage unit 120. Display and storage unit 120 may also contain an apparatus for supplying control signals and power to EM logging tool 100 in casing string 108.

A typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. Such as, a first casing 134 and a second casing 136. It should be noted that there may be any number of casing layers.

FIG. 1 also illustrates a typical pipe string 138, which may be positioned inside of casing string 108 extending part of the distance down wellbore 110. Pipe string 138 may be production tubing, tubing string, casing string, or other pipe disposed within casing string 108. Pipe string 138 may comprise one or more tubulars. It should be noted that one or more tubulars may be connected by collars 132. EM logging tool 100 may be dimensioned so that it may be lowered into the wellbore 110 through pipe string 138, thus avoiding the difficulty and expense associated with pulling pipe string 138 out of wellbore 110.

EM logging tool 100 may include a digital telemetry system which may further include one or more electrical circuits, not illustrated, to supply power to EM logging tool 100 and to transfer data between display and storage unit 120 and EM logging tool 100. A DC voltage may be provided to EM logging tool 100 by a power supply located above ground level, and data may be coupled to the DC power conductor by a baseband current pulse system. Alternatively, EM logging tool 100 may be powered by batteries located within EM logging tool 100 and data provided by EM logging tool 100 may be stored within EM logging tool 100, rather than transmitted to the surface to display and storage unit 120 during logging operations. The data may include signals and measurements related to corrosion detection.

During operations, transmitter 102 may broadcast electromagnetic fields into subterranean formation 142. It should be noted that broadcasting electromagnetic fields may also be referred to as transmitting electromagnetic fields. The electromagnetic fields transmitted from transmitter 102 may be referred to as a primary electromagnetic field. The primary electromagnetic fields may produce Eddy currents in casing string 108 and pipe string 138. These Eddy currents, in turn, produce secondary electromagnetic fields that may be sensed and/or measured by receivers 104. Characterization of casing string 108 and pipe string 138, including determination of pipe attributes, may be performed by measuring and processing primary and secondary electromagnetic fields. Pipe attributes may include, but are not limited to, pipe thickness, pipe conductivity, and/or pipe permeability.

As illustrated, receivers 104 may be positioned on EM logging tool 100 at selected distances (e.g., axial spacing) away from transmitters 102. The axial spacing of receivers 104 from transmitters 102 may vary, for example, from about 0 inches (0 cm) to about 40 inches (101.6 cm) or more. It should be understood that the configuration of EM logging tool 100 shown on FIG. 1 is merely illustrative and other configurations of EM logging tool 100 may be used with the present techniques. A spacing of 0 inches (0 cm) may be achieved by collocating coils with different diameters. While FIG. 1 shows only a single array of receivers 104, there may be multiple sensor arrays where the distance between transmitter 102 and receivers 104 in each of the sensor arrays may vary. In addition, EM logging tool 100 may include more than one transmitter 102 and more or less than six receivers 104. In addition, transmitter 102 may be a coil implemented for transmission of magnetic field while also measuring EM fields, in some instances. Where multiple transmitters 102 are used, their operation may be multiplexed or time multiplexed. For example, a single transmitter 102 may broadcast, for example, a multi-frequency signal or a broadband signal. While not shown, EM logging tool 100 may include a transmitter 102 and receiver 104 that are in the form of coils or solenoids coaxially positioned within a downhole tubular (e.g., casing string 108) and separated along the tool axis. Alternatively, EM logging tool 100 may include a transmitter 102 and receiver 104 that are in the form of coils or solenoids coaxially positioned within a downhole tubular (e.g., casing string 108) and collocated along the tool axis.

Broadcasting of EM fields by transmitter 102 and the sensing and/or measuring of secondary electromagnetic fields by receivers 104 may be controlled by display and storage unit 120, which may include an information handling system 144. As illustrated, the information handling system 144 may be a component of or be referred to as the display and storage unit 120, or vice-versa. Alternatively, the information handling system 144 may be a component of EM logging tool 100. An information handling system 144 may include any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price.

Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with EM logging tool 100 and/or software executed by processing unit 146. For example, information handling system 144 may enable an operator to select analysis options, view collected log data, view analysis results, and/or perform other tasks.

EM logging tool 100 may use any suitable EM technique based on Eddy current (“EC”) for inspection of one or more tubulars (e.g., casing string 108 and pipe string 138). EC techniques may be particularly suited for characterization of a multi-string arrangement in which one or more tubulars. EC techniques may include, but are not limited to, frequency-domain EC techniques and time-domain EC techniques.

In frequency domain EC techniques, transmitter 102 of EM logging tool 100 may be fed by a continuous sinusoidal signal, producing primary magnetic fields that illuminate the one or more tubulars (e.g., casing string 108 and pipe string 138). The primary electromagnetic fields produce Eddy currents in the one or more tubulars. These Eddy currents, in turn, produce secondary electromagnetic fields that may be sensed and/or measured with the primary electromagnetic fields by receivers 104. Characterization of the one or more tubulars may be performed by measuring and processing these electromagnetic fields.

In time domain EC techniques, which may also be referred to as pulsed EC (“PEC”), transmitter 102 may be fed by a pulse. Transient primary electromagnetic fields may be produced due the transition of the pulse from “off” to “on” state or from “on” to “off” state (more common). These transient electromagnetic fields produce EC in the one or more tubulars (e.g., casing string 108 and pipe string 138). The EC, in turn, produce secondary electromagnetic fields that may be sensed and/or measured by receivers 104 placed at some distance on EM logging tool 100 from transmitter 102, as shown on FIG. 1. Alternatively, the secondary electromagnetic fields may be sensed and/or measured by a co-located receiver (not shown) or with transmitter 102 itself.

It should be understood that while casing string 108 is illustrated as a single casing string, there may be one or more tubulars disposed in the section of wellbore 110 with casing string 108. EM log data may be obtained in two or more sections of wellbore 110 with multiple layers of one or more tubulars. For example, EM logging tool 100 may make a first measurement of pipe string 138 comprising any suitable number of joints 130 connected by collars 132. Measurements may be taken in the time-domain and/or frequency range. EM logging tool 100 may make a second measurement in a casing string 108 of first casing 134, wherein first casing 134 comprises any suitable number of tubulars connected by collars 132. Measurements may be taken in the time-domain and/or frequency domain. These measurements may be repeated any number of times for first casing 134, for second casing 136, and/or any additional layers of casing string 108. In this disclosure, as discussed further below, methods may be utilized to determine the location of any number of collars 132 in casing string 108 and/or pipe string 138. Determining the location of collars 132 in the frequency domain and/or time domain may allow for accurate processing of recorded data in determining properties of casing string 108 and/or pipe string 138 such as corrosion. As mentioned above, measurements may be taken in the frequency domain and/or the time domain.

In frequency domain EC, the frequency of the excitation may be adjusted so that multiple reflections in the wall of the pipe (e.g., casing string 108 or pipe string 138) are insignificant, and the spacing between transmitters 102 and/or receiver 104 is large enough that the contribution to the mutual impedance from the dominant (but evanescent) waveguide mode is small compared to the contribution to the mutual impedance from the branch cut component. In examples, a remote-field eddy current (RFEC) effect may be observed. In a RFEC regime, the mutual impedance between the coil of transmitter 102 and coil of one of the receivers 104 may be sensitive to the thickness of the pipe wall. To be more specific, the phase of the impedance varies in Equation (1) as:

$$φ = 2 \sqrt{\frac{ω μ σ}{2}} t \qquad ( 1 )$$

and the magnitude of the impedance shows the dependence in Equation (2) as:

$$exp [ - 2 ( \sqrt{\frac{ω μ σ}{2}} ) t ] \qquad ( 2 )$$

where ω is the angular frequency of the excitation source, μ is the magnetic permeability of the pipe, σ is the electrical conductivity of the pipe, t is the thickness of the pipe, φ is phase of impedance, and δ is skin depth. By using the common definition of skin depth for the metals in Equation (3) as:

$$δ = \sqrt{\frac{2}{ω μ σ}} \qquad ( 3 )$$

The phase of the impedance varies as in Equation (4) as:

$$φ ≅ 2 \frac{t}{δ} \qquad ( 4 )$$

and the magnitude of the impedance shows the dependence in Equation (5) as:

$$exp [ \frac{- 2 t}{δ} ] \qquad ( 5 )$$

In RFEC, the estimated quantity may be the overall thickness of the metal. Thus, for multiple one or more tubulars, the estimated parameter may be the overall or sum of the thicknesses of one or more tubulars. The quasi-linear variation of the phase of mutual impedance with the overall metal thickness may be employed to perform fast estimation to estimate the overall thickness of multiple one or more tubulars. For this purpose, for any given set of tubulars dimensions, material properties, and tool configuration, such linear variation may be constructed quickly and may be used to estimate the overall thickness of one or more tubulars. Information handling system 144 may enable an operator to select analysis options, view collected log data, view analysis results, and/or perform other tasks.

Monitoring the condition of pipe string 138 and casing string 108 may be performed on information handling system 144 in oil and gas field operations. Information handling system 144 may be utilized with Electromagnetic (EM) Eddy Current (EC) techniques to inspect pipe string 138 and casing string 108. EM EC techniques may include frequency-domain EC techniques and time-domain EC techniques. In time-domain and frequency-domain techniques, one or more transmitters 102 may be excited with an excitation signal which broadcast an electromagnetic field and receiver 104 may sense and/or measure the reflected excitation signal, a secondary electromagnetic field, for interpretation. The received signal is proportional to the amount of metal that is around transmitter 102 and receiver 104. For example, less signal magnitude is typically an indication of more metal, and more signal magnitude is an indication of less metal. This relationship may be utilized to determine metal loss, which may be due to an abnormality related to the pipe such as corrosion or buckling.

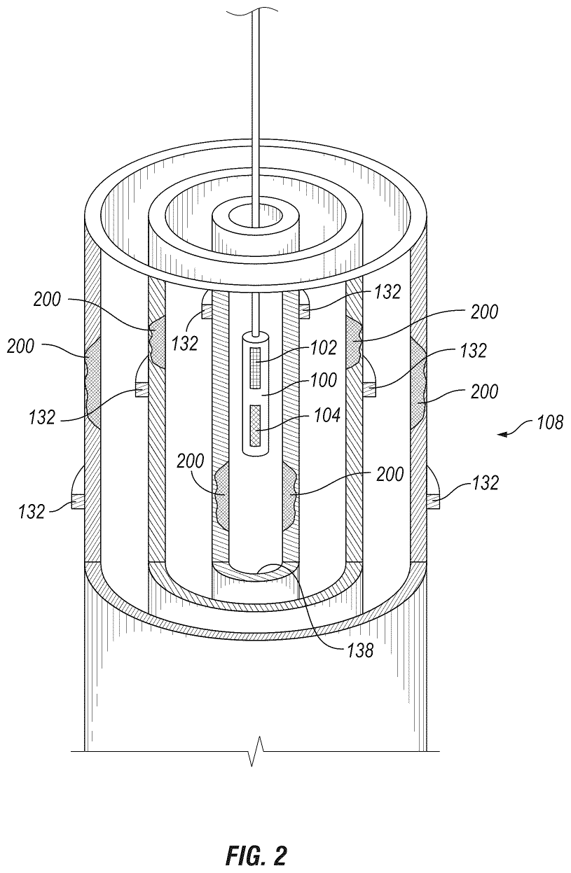

FIG. 2 illustrates EM logging tool 100 disposed in pipe string 138 which may be surrounded by one or more tubulars (e.g., first casing 134 and second casing 136) and an illustration of anomalies 200 disposed within one or more tubulars, in accordance with some embodiments. As EM logging tool 100 moves across pipe string 138 and casing string 108, one or more transmitters 102 may be excited, and a signal (mutual impedance between 102 transmitter and receiver 104) at one or more receivers 104, may be recorded.

Due to eddy current physics and electromagnetic attenuation, pipe string 138 and/or casing string 108 may generate an electrical signal that is in the opposite polarity to the incident signal and results in a reduction in the received signal. Typically, more metal volume translates to more lost signal. As a result, by inspecting the signal gains, it is possible to identify zones with metal loss (such as corrosion). In order to distinguish signals that originate from anomalies at different tubulars of a multiple nested pipes configuration, multiple transmitter-receiver spacing, and frequencies may be utilized. For example, short spaced transmitters 102 and receivers 104 may be sensitive to first casing 134, while longer spaced transmitters 102 and receivers 104 may be sensitive to second casing 136 and/or deeper (3rd, 4th, etc.) tubulars. By analyzing the signal levels at these different channels with inversion methods, it is possible to relate a certain received signal to a certain metal loss or gain at each pipe. In addition to loss of metal, other pipe properties such as magnetic permeability and conductivity may also be estimated by inversion methods. It should be noted that inversion methods may include model-based inversion which may include forward modeling. However, there may be factors that complicate interpretation of losses. For example, deep pipe signals may be significantly lower than other signals. Double dip indications appear for long spaced transmitters 102 and receivers 104. Spatial spread of long spaced transmitter-receiver signals for a collar 132 may be long (up to 6 feet (1.8 meters)). Due to these complications, methods may need to be used to accurately inspect pipe features. Inspection of pipe figures may at least partially be performed on information handling system 144.

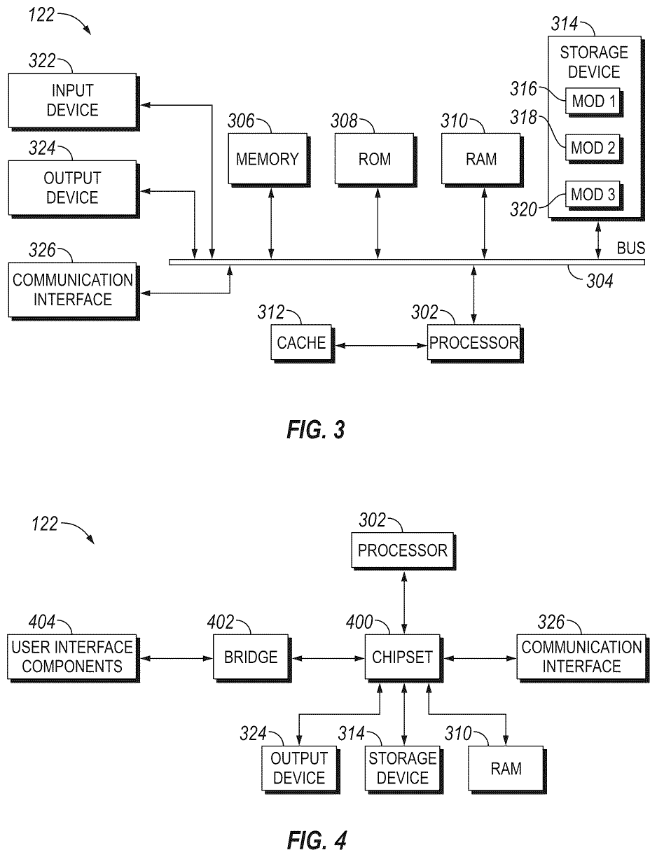

FIG. 3 illustrates an example information handling system 144 which may be employed to perform various steps, methods, and techniques disclosed herein. As illustrated, information handling system 144 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 144 may include a cache 312 of high-speed memory connected directly with, in close proximity to, or integrated as part of processor 302. Information handling system 144 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may include multiple different types of memory with different performance characteristics. It may be appreciated that the disclosure may operate on information handling system 144 with more than one processor 302 or on a group or cluster of computing devices networked together to provide greater processing capability. Processor 302 may include any general purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as memory 306 or cache 312 or may operate using independent resources. Processor 302 may include one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 144, such as during start-up. Information handling system 144 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 144 may include other hardware or software modules. Storage device 314 is connected to the system bus 304 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 144 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 322 represents any number of input mechanisms, such as a microphone for speech, a touch-sensitive screen for gesture or graphical input, keyboard, mouse, motion input, speech and so forth. Additionally, input device 322 may take in data from one or more sensors 136, discussed above. An output device 324 may also be one or more of a number of output mechanisms known to those of skill in the art. In some instances, multimodal systems enable a user to provide multiple types of input to communicate with information handling system 144. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 302 to perform particular functions according to the programming of software modules 316, 318, and 320.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization compute layer may operate on top of a physical compute layer. The virtualization compute layer may include one or more virtual machines, an overlay network, a hypervisor, virtual switching, and any other virtualization application.

FIG. 4 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. A bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 144 may come from any of a variety of sources, machine generated and/or human generated.

Chipset 400 may also interface with one or more communication interfaces 326 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 144 receive inputs from a user via user interface components 404 and execute appropriate functions, such as browsing functions by interpreting these inputs using processor 302.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

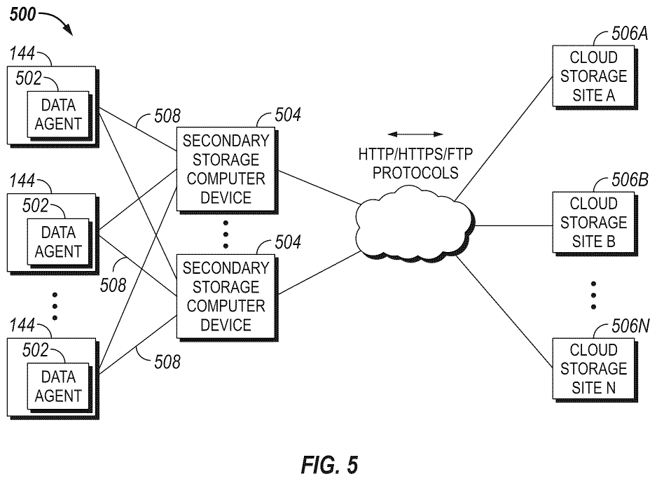

FIG. 5 illustrates an example of one arrangement of resources in a computing network 500 that may employ the processes and techniques described herein, although many others are of course possible. As noted above, an information handling system 122, as part of their function, may utilize data, which includes files, directories, metadata (e.g., access control list (ACLS) creation/edit dates associated with the data, etc.), and other data objects. The data on the information handling system 122 is typically a primary copy (e.g., a production copy). During a copy, backup, archive or other storage operation, information handling system 122 may send a copy of some data objects (or some components thereof) to a secondary storage computing device 504 by utilizing one or more data agents 502.

A data agent 502 may be a desktop application, website application, or any software-based application that is run on information handling system 122. As illustrated, information handling system 122 may be disposed at any rig site (e.g., referring to FIG. 1) or repair and manufacturing center. Data agent 502 may communicate with a secondary storage computing device 504 using communication protocol 508 in a wired or wireless system. Communication protocol 508 may function and operate as an input to a website application. In the website application, field data related to pre- and post-operations, generated DTCs, notes, and the like may be uploaded. Additionally, information handling system 122 may utilize communication protocol 508 to access processed measurements, operations with similar DTCs, troubleshooting findings, historical run data, and/or the like. This information is accessed from secondary storage computing device 504 by data agent 502, which is loaded on information handling system 122.

Secondary storage computing device 504 may operate and function to create secondary copies of primary data objects (or some components thereof) in various cloud storage sites 506A-N. Additionally, secondary storage computing device 504 may run determinative algorithms on data uploaded from one or more information handling systems 144, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain DTC code logs for each downhole operation or run, map DTC codes, store repair and maintenance data, store operational data, and/or provide outputs from determinative algorithms that are fun at cloud storage sites 506A-N. In examples, computing network 500 may be communicatively coupled to downhole fluid sampling tool 100. Information handling system 144 described herein may be operable to interface with EM logging tool 100 (e.g., referring to FIG. 1) for pipe inspection of defects.

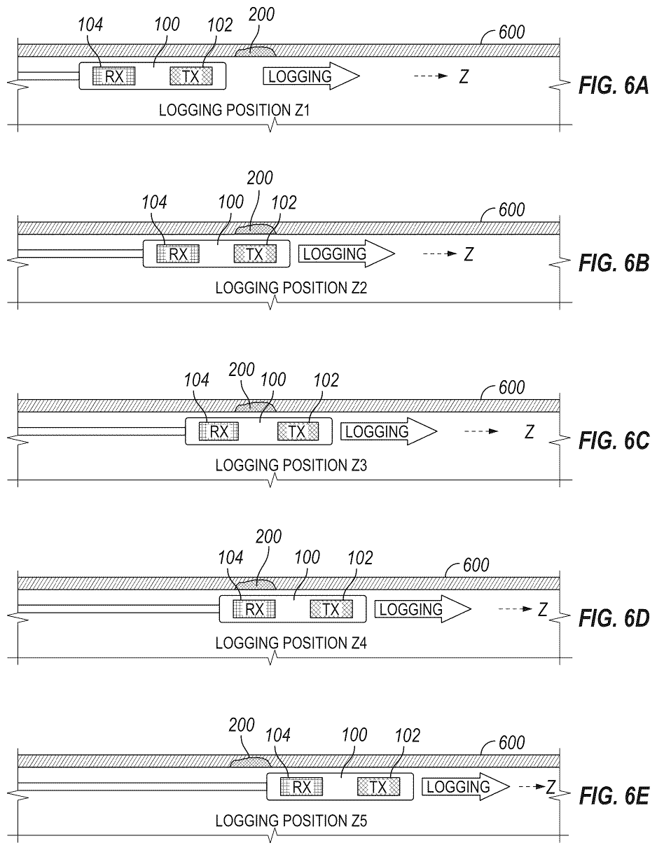

FIG. 6A illustrates an electromagnetic inspection and detection of anomalies 200 (e.g., defects) or collars 132 (e.g., Referring to FIG. 2), in accordance with some embodiments. FIG. 6B illustrates an electromagnetic inspection and detection of anomalies 200 or collars 132 disposed deeper along the z axis in reference to FIG. 6A. FIG. 6C illustrates an electromagnetic inspection and detection of anomalies 200 or collars 132 disposed deeper along the z axis in reference to FIG. 6B. FIG. 6D illustrates an electromagnetic inspection and detection of anomalies 200 or collars 132 disposed deeper along the z axis in reference to FIG. 6C. FIG. 3E illustrates an electromagnetic inspection and detection of anomalies 200 or collars 132 disposed deeper along the z axis in reference to FIG. 6D. As illustrated, EM logging tool 100 may be disposed in pipe string 138, by a conveyance, which may comprise any number of one or more tubulars. As EM logging tool 100 traverses across pipe 600, one or more transmitters 102 may be excited, and a signal (mutual impedance between transmitter 102 and receiver 104) at one or more receivers 104, may be recorded. Due to eddy currents and electromagnetic attenuation, pipe 600 may generate an electrical signal that is in the opposite polarity to the incident signal and results in a reduction in a received signal. Thus, more metal volume translates to greater signal lost. As a result, by inspecting the signal gains, it may be possible to identify zones with metal loss (such as corrosion). This may comprise buckling, dents, collapses, or ridges. Similarly, by inspecting the signal loss, it may be possible to identify metal gain such as due to presence of a casing collar 132 (e.g., Referring to FIG. 1) where two tubulars meet with a threaded connection. In order to distinguish signals from different tubulars in a multiple concentric pipe configuration, multiple transmitter-receiver spacing, and frequencies may be used. For example, short spaced transmitters 102 and receivers 104 may be sensitive to pipe string 138, while long spaced transmitters 102 and receivers 104 may be sensitive to deeper tubulars (e.g., first casing 134, second casing 136, etc.). By analyzing the signal levels at these different channels through a process of inversion, it may be possible to relate a certain received signal set to a certain set of metal loss or gain at each pipe. In examples, there may be factors that complicate the interpretation and/or identification of collars 132 and/or anomalies 200 (e.g., defects).

For example, due to eddy current physics and electromagnetic attenuation, tubulars disposed in pipe string 138 (e.g., referring to FIG. 1 and FIG. 2) may generate an electrical signal that may be in the opposite polarity to the incident signal and results in a reduction in the received signal. Generally, as metal volume increases the signal loss may increase. As a result, by inspecting the signal gains, it may be possible to identify zones with metal loss (such as corrosion). In order to distinguish signals that originate from anomalies 200 (e.g., defects) at different tubulars of a multiple nested pipes configuration, multiple transmitter-receiver spacing, and frequencies may be used. For example, short spaced transmitters 102 and receivers 104 may be sensitive to first pipe string 138 (e.g., referring to FIG. 2), while long spaced transmitters 102 and receivers 104 may be sensitive to deeper (2^{nd}, 3^{rd}, etc.) tubulars (e.g., first casing 134 and second casing 136).

Analyzing the signal levels at different channels with an inversion scheme, it may be possible to relate a certain received signal to a certain metal loss or gain at each pipe. In addition to loss of metal, other pipe properties such as magnetic permeability, electrical conductivity individual thickness of each pipe, percentage metal loss or gain of each pipe, the individual magnetic permeability of each pipe, the individual electrical conductivity of each pipe, the total thickness of each pipe, the eccentricity of each pipe, and the inner diameter of each pipe. may also be estimated by inversion. There may be several factors that complicate interpretation of losses. For example, factors may comprise deep pipe signals that are significantly lower than other signals. In addition, double dip indications appear for long spaced transmitters 102 and receivers 104 may be another factor which complicates interpretation of losses. Further, factors may comprise spatial spread of long spaced transmitter-receiver signal for a collar 132 up to 6 feet long, material properties of the tubulars such as magnetic permeability and electrical conductivity, and a non-unique inversion which may output multiple solutions to the same set of inputs. Due to these factors, an advanced algorithm or workflow may be used to accurately inspect pipe features, for example when more than two tubulars may be present in pipe string 138.

During logging operations as EM logging tool 100 traverses across pipe 600 (e.g., referring to FIG. 6), an EM log of the received signals may be produced and analyzed. The EM log may be calibrated prior to running inversion to account for the deviations between measurement and simulation (forward model). The deviations may arise from several factors, including the nonlinear behavior of the magnetic core, magnetization of tubulars, mandrel effect, and inaccurate well plans. Multiplicative coefficients and constant factors may be applied, either together or individually, to the measured EM log for calibration. Calibration is important when multiple tubulars are inspected. It is common for well plans to have multiple tubulars.

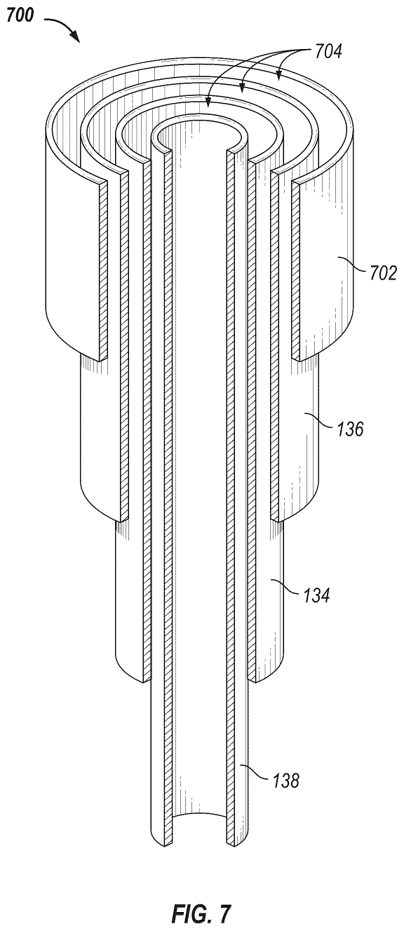

FIG. 7 illustrates an example of a multiple tubular well plan 700 in accordance with some embodiments. Depending on the design of well plan 700, well construction may have between two and four main components. These components include conductor, surface, intermediate and production casings. After completion of the well, a tubing may be inserted to pump hydrocarbon products. In this example, well plan 700 may comprise one or more tubulars. For example, pipe string 138, first casing 134, second casing 136, a conductor casing 702, and wherein cement may be disposed in annulus 704 between each casing. However, it should be noted that well plan 700 may include any number of tubulars, casings, tubulars, and/or the like. Well plan 700 is not limited or bound by the four tubulars that are displayed in FIG. 7. When EM logging tool 100 is used to monitor the pipe condition a log may be produced.

Monitoring the condition of the casing strings is crucial in oil and gas field operations. As discussed above, EM techniques may be used to inspect tubulars, casings, tubulars, and/or the like. Generally, an eddy current (EC) technique is a common EM technique that is utilized for monitoring the condition of casing strings. In EC, when the transmitter coil emits the primary transient EM fields, eddy current is induced in the surrounding casings. The eddy currents then produce secondary fields, which may be received along with the primary fields by one or more receivers 104. EM logging tool 100 may utilize two or more transmitters 102 and may utilize two or more receivers 104, operating at multi-frequencies. In addition, one transmitter 102 may also be configured to transmit EM fields at multiple frequencies. Further, two or more transmitters may also transmit EM fields at the same frequency.

By using the measurements from the configurations described above, the thickness of pipe string 138, first casing 134, second casing 136, etc. (e.g., referring to FIGS. 1 and 7) may be obtained through methods discussed below. In examples, measurements described herein may be multi-frequency and multi-spacing measurements recorded by a frequency-domain tool, recorded by a time-domain tool at receivers with different sizes and at different time delays, and are acquired with different transmitters active at different times. Different depths of penetration, axial and vertical resolutions may be achieved via several receivers 104 and several transmitters 102 placed at various positions. Transmitters 102 that are placed at a shorter distance from receivers 104, may measure the response due to the inner pipes with better axial and vertical resolution. Transmitters 102 that are at longer distances from receivers 104 may measure responses of outer pipes but with degraded resolution. Thus, an electromagnetic log may be first acquired and then processed to invert all casing information with one run.

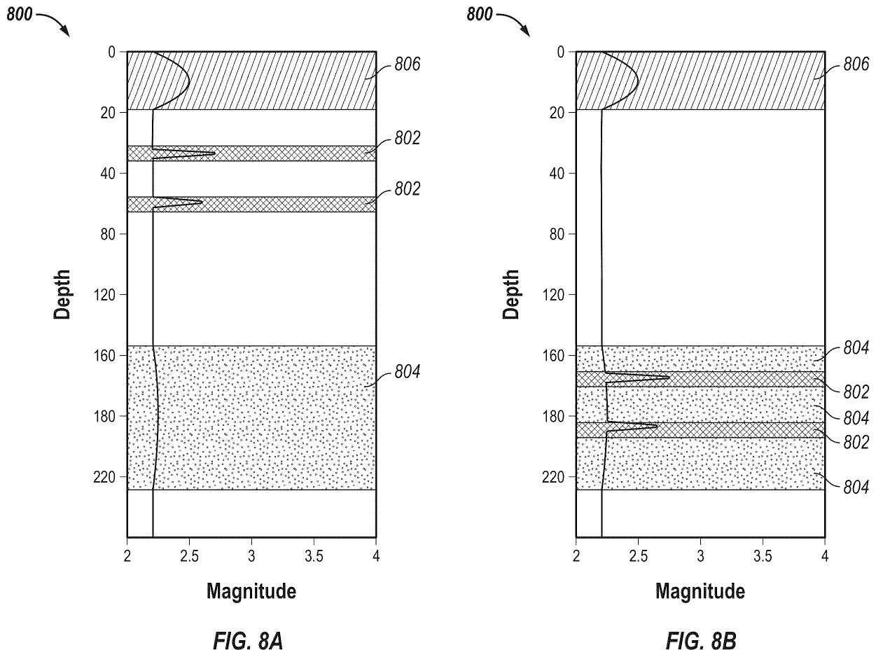

FIG. 8A illustrates an example of electromagnetic (EM) log data 800 in with two or more nested pipes. EM log data may comprise distortions which may be indicative of one or more structural irregularity zones. Herein, the actual effects of structural irregularity zones may be shown on the data as EM log distortions. Examples of structural irregularity zones may comprise downhole pipe localized defect zones 802, eccentricity zones 804, and deformation zones 806. Localized defect zones 802 may be within a relatively small range (a few inches). Eccentricity zones 804 occurs in a large scale and the variation in signal is slow compared to that caused by deformation or corrosion. FIG. 8B illustrates EM log data 800 with an overlap in eccentricity zones 804. In terms of scale, deformation is between eccentricity and localized corrosion. The magnitude of variation in signal caused by deformation depends on the severity of it. Eccentricity, deformation and localized defects/corrosion may occur at separate depths or coexist on the same depth interval. FIGS. 8A and 8B illustrate EM log data 800 in spatial domain, however spectral analysis may be applied to the data. In examples, the spectral analysis may be applied on the whole log or in a sliding window.

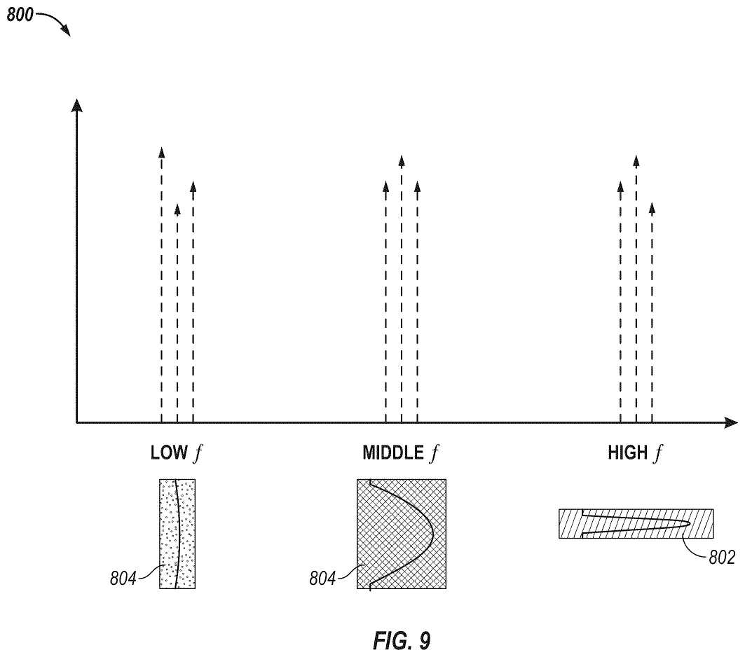

FIG. 9 illustrates electromagnetic (EM) log data 800 with distortions of structural irregularity zones plotted as a spectrum. Eccentricity zones 804 correspond to the low frequency signal. Localized defect zones 802 mainly correspond to the high frequency signal. Deformation zones 806 corresponds to the middle frequency signal. Based on spectrum, it may be possible to differentiate among localized defect zones 802, eccentricity zones 804, and deformation zones 806. After determining the deformation zone 806, the magnitude and orientation of variation in EM log distortion may be used to qualitatively determine the structural irregular zone type and severity. Different examples are shown below to prove the capability of the method.

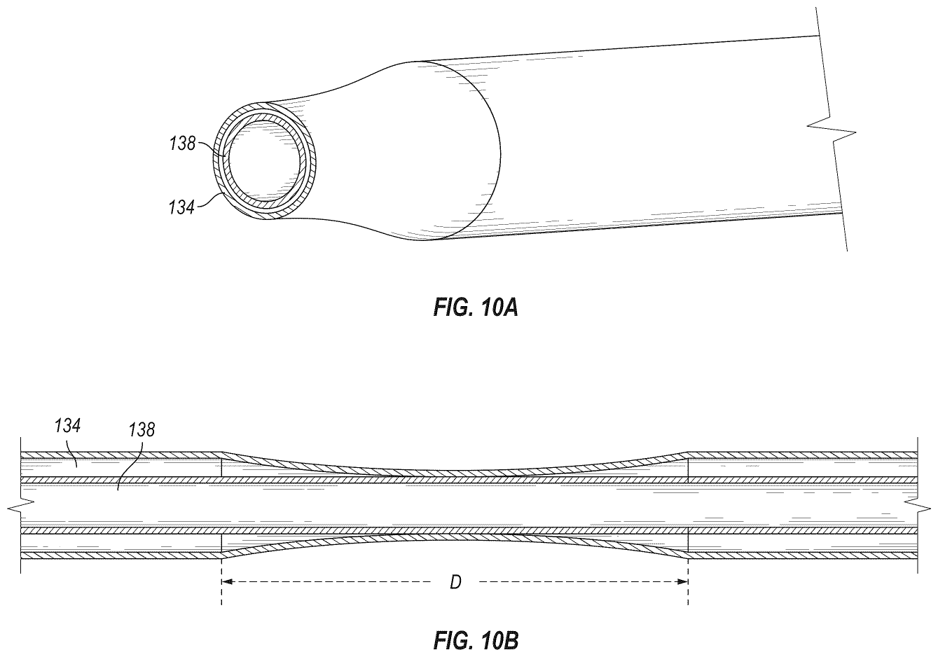

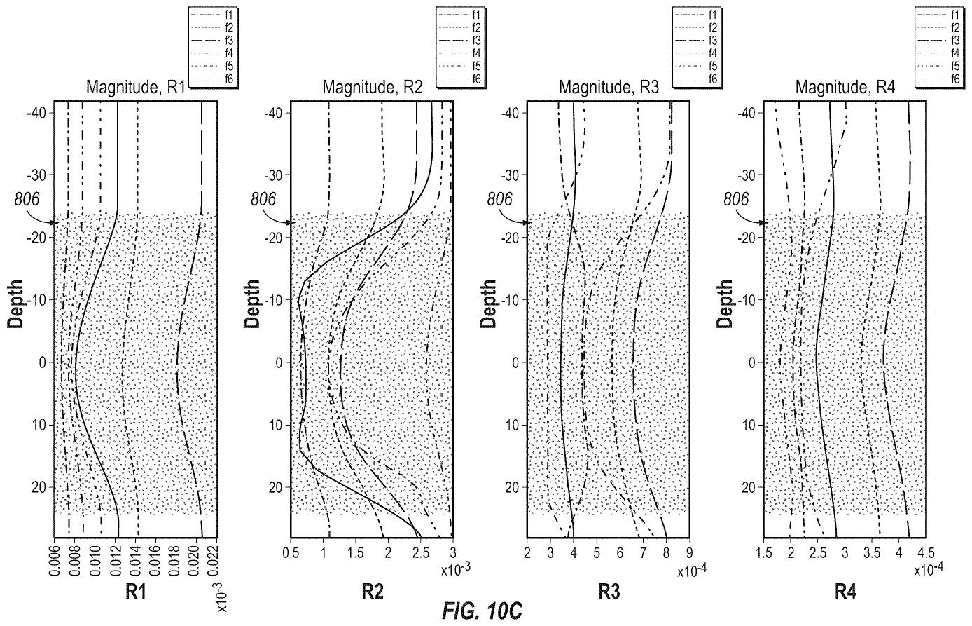

FIGS. 10A and B illustrate a configuration of a first example with two or more nested pipes. In this example, there are two tubular pipes: pipe string 138 and first casing 134. Pipe string 138 is intact, while there is a 4 ft-long collapse on first casing 138. The electromagnetic (EM) logging tool 100 (e.g., referring to FIG. 1) is logged inside pipe string 138. FIG. 10C illustrates the acquired electromagnetic log data 800 for four receivers 104 placed at different spacings from transmitter 102 operating at six different frequencies. Depth alignment and a baseline removal to the EM log for removing eccentricity effect may be applied on the data. Therefore, the collapse is shown at the same depth range for different receivers 104. The signal level is reduced in the collapse range. The reduced signal ranges from −24 inches to 24 inches, which is exactly the length of the collapse. Receivers 2 and 3 may be more sensitive in this case compared to receiver 1 and receiver 4. Additional examples may be provided below.

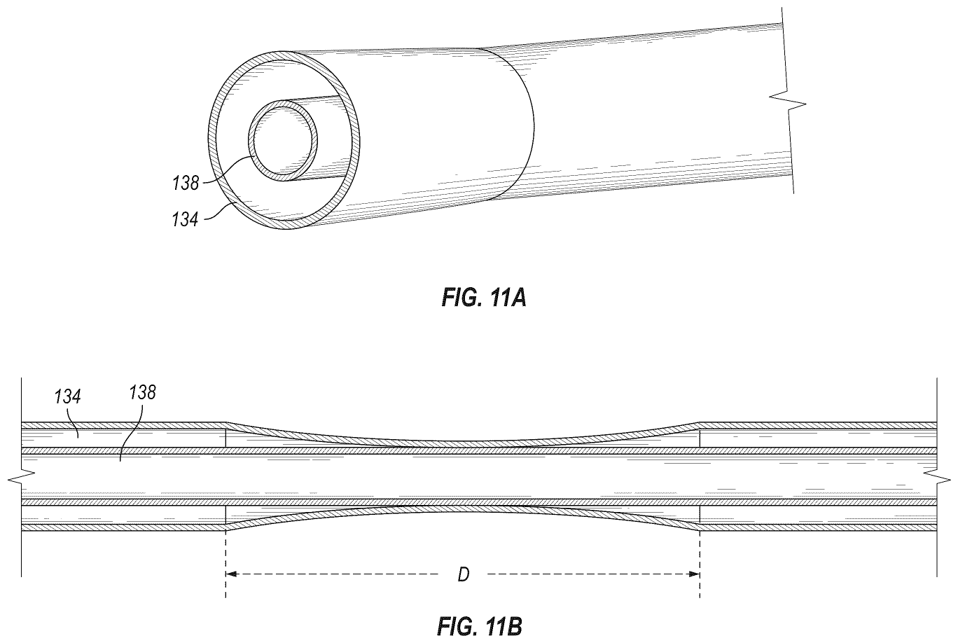

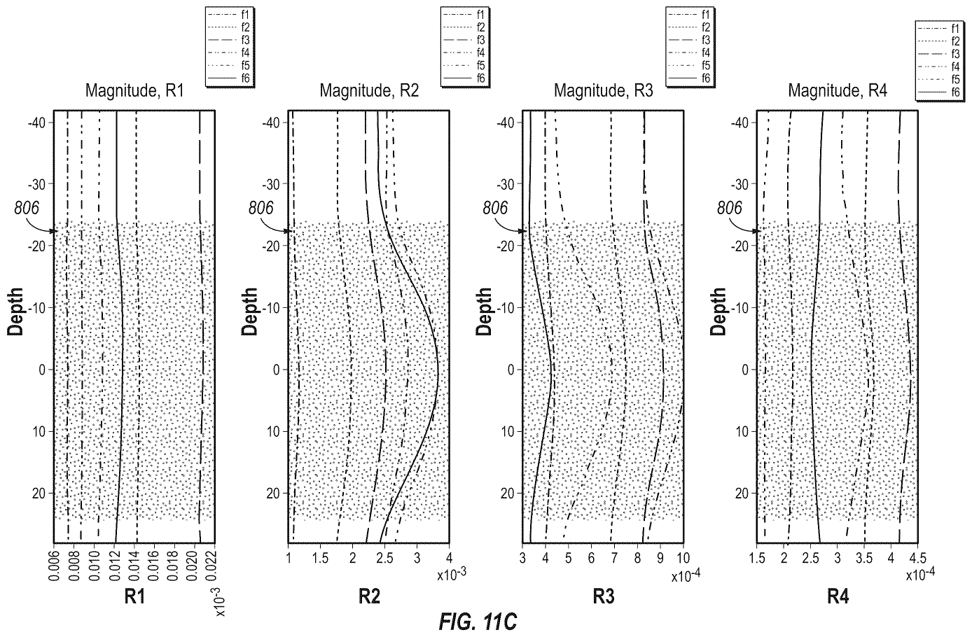

FIGS. 11A and B illustrate a configuration of a second example with two or more nested pipes. In this example, there are two tubular pipes: pipe string 138 and first casing 134. Pipe string 138 is intact, while there is a 4 ft-long deformation zone on pipe string 138. The electromagnetic (EM) logging tool 100 (e.g., referring to FIG. 1) is logged inside pipe string 138. FIG. 11C illustrates the acquired electromagnetic log data 800 for four receivers 104 placed at different spacings from transmitter 102 operating at six different frequencies. Depth alignment may be applied on the data. Therefore, the burst is shown at the same depth range for different receivers 104. The signal level is increased in the burst range. The increased signal ranges from −24 inches to 24 inches, which is exactly the length of the burst. Additional examples may be provided below.

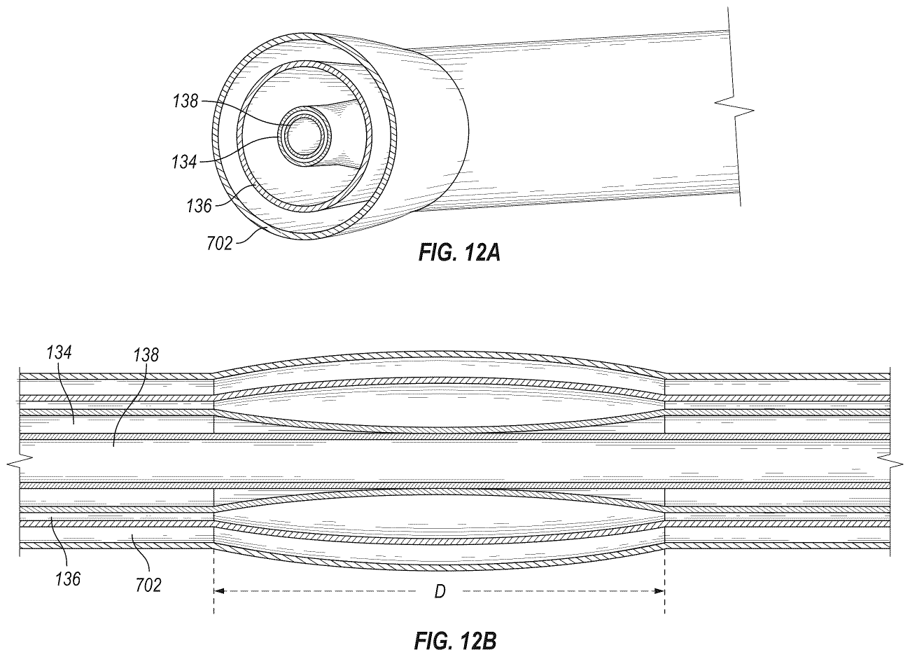

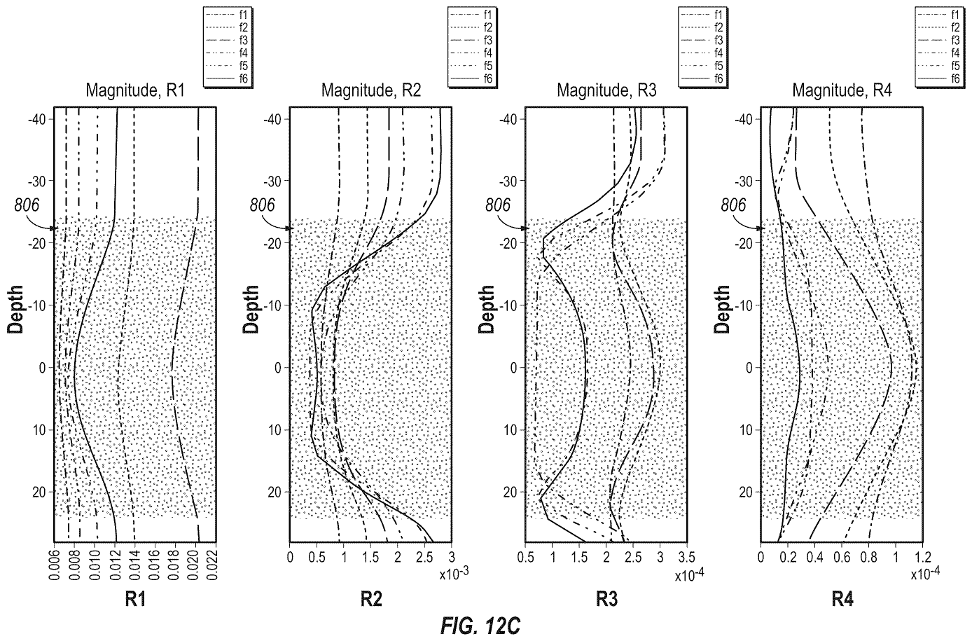

FIGS. 12A and B illustrate a configuration for a third example with two or more nested pipes. There are four tubular pipes. Pipe string 138 is intact, first casing 134 may comprise a 4 ft-long collapse, and second casing string 136 and conductor casing 702 may comprise a 4 ft-long burst. The electromagnetic (EM) logging tool 100 (e.g., referring to FIG. 1) is logged inside pipe string 138. FIG. 12C illustrates the acquired data for four receivers placed at different spacings from the transmitter operating at six different frequencies. Depth alignment is applied on the data. Therefore, different structural irregular zones on different pipes are shown at the same depth range for different receivers. From examples 1 and 2, the burst is shown as increased signal, while collapse is shown as reduced signal. The signal variation ranges from −24 inches to 24 inches, which is exactly the length of the structural irregular zone. The signal of receiver 1 shows purely decreased signal from −24 to 24 inches.

It indicates collapse in the inner pipes. For receiver 2, a majority of the signal is shown as decreased. However, for the signal at frequency 6, there is a small hump around depth 0 inch. For receiver 3, signals at high frequencies (frequency 4, frequency 5, frequency 6) are shown as decreased but with a small hump around depth 0 inch, while signals at low frequencies (frequency 1, frequency 2, frequency 3) are shown as increased. It indicates there is collapse on the inner pipe—pipe string 138 and bursts on the outer pipes—second casing string 136 and conductor casing 702. For receiver 4, it is the farthest receiver from the transmitter. Therefore, receiver 4's depth of investigation is the largest. It shows purely sensitivity to the 4th pipe and the signal level is increased from depth-24 to 24 inches. This example proves that the multi-frequency and multi-spacing receiver signals shows good sensitivity to different types of structural irregular zones on multiple tubular pipes.

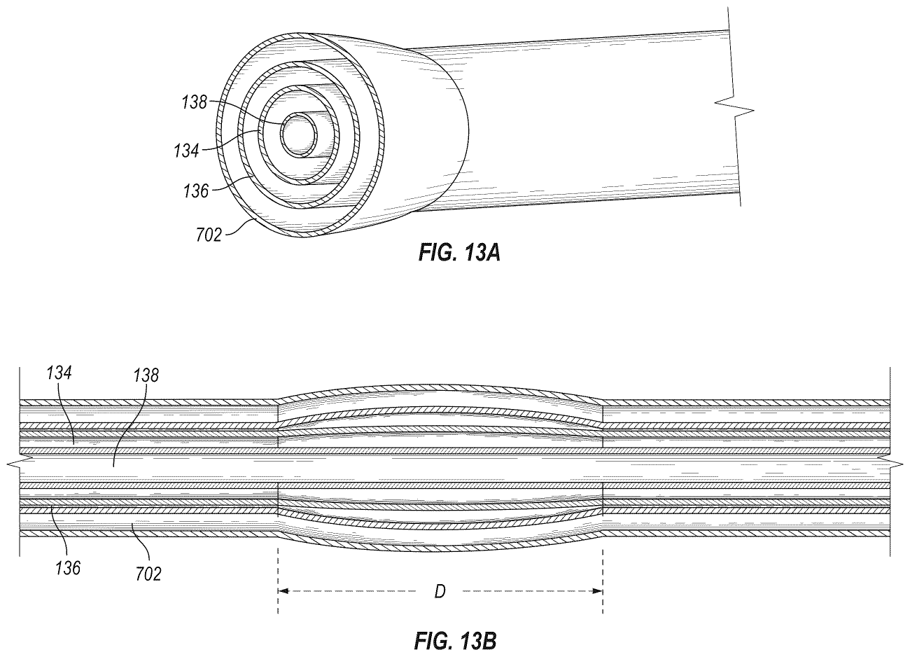

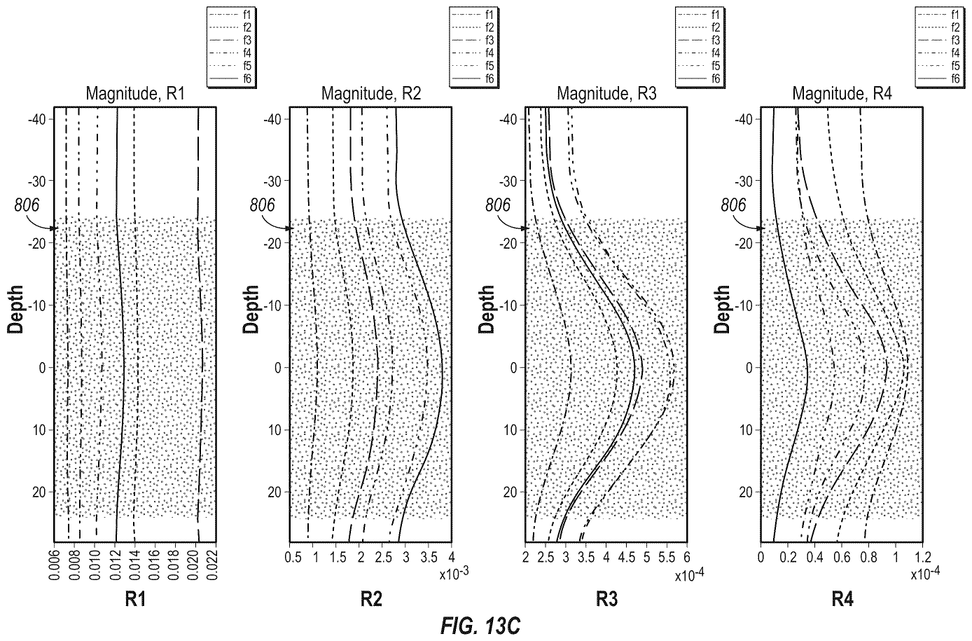

FIGS. 13A and B illustrate a configuration for a fourth example with two or more nested pipes. There are four tubular pipes. Pipe string 138 is intact, while first casing 134 second casing string 136, and conductor casing 702 may comprise a 4 ft-long burst. The electromagnetic (EM) logging tool 100 (e.g., referring to FIG. 1) is logged inside pipe string 138. FIG. 13C illustrates the acquired data for four receivers placed at different spacings from the transmitter operating at six different frequencies. Depth alignment is applied on the data. Therefore, different structural irregular zones on different pipes are shown at the same depth range for different receivers. From examples 1, 2, and 3 the burst is shown as increased signal, while collapse is shown as reduced signal. The signal variation ranges from −24 inches to 24 inches, which is exactly the length of the structural irregular zone. The signal of receiver 1 shows purely increased signal from −24 to 24 inches.

The signal of receiver 1 barely shows sensitivity to the structural irregular zone on the pipes. Starting from receiver 2, the signal shows sensitivity to the structural irregular zone. It shows purely increased signal from −24 to 24 inches for receiver 2, 3, 4. And there is no concave around depth 0. It indicates there are purely bursts on the outer pipes and the innermost 1st pipe is highly likely to be intact. This example proves that the multi-frequency and multi-spacing receiver signals show good sensitivity to structural irregular zones on multiple tubular pipes.

The analysis above is all qualitative. If a quantitative result is required, e.g., the size and severity of the structural irregular zone, radial one dimensional (R1D) inversion can be applied to the data to invert the severity of the structural irregular zone.

Data mapping method is also an option. It can comprise: (1) Building a database for different severity of different types of structural irregular zone (e.g., bursts, collapse) for different signals. (2) Mapping the measured signal in the database to find the best severity of the structural irregular zone. Or it can comprise: (1) Building a mathematical relationship of structural irregular zone severity and signal level. (2) Mapping the signal using the mathematical relationship to invert the structural irregular zone size and severity.

Different signal processing methods can also be applied to invert the quantitative results. It may be machine learning based method and deep learning method.

Improvements over current technology described above comprise determining structural irregular zones qualitatively and quantitatively. Compared to corrosion, the range and size of structural irregular zone are usually much larger, and the variation is much slower. The pattern of manifestation for structural irregular zone is quite different from that of corrosion. Methods and systems herein show that the current electromagnetic logging tools may also help to detect different types of structural irregular zone in multiple pipes. This will greatly extend the covering range of our answer products in pipe integrity inspection.

The preceding description provides various examples of the systems and methods of use disclosed herein which may contain different method steps and alternative combinations of components.

Statement 1. A method comprising: disposing an electromagnetic (EM) logging tool in a wellbore, wherein the EM logging tool comprises: one or more transmitters disposed on the EM logging tool; and one or more receivers disposed on the EM logging tool; transmitting a first EM field from the one or more transmitters into two or more nested pipes to energize the two or more nested pipes with the first EM field thereby producing an eddy current in the one or more nested pipes; measuring a second EM field generated by the eddy current in the two or more nested pipes with the one or more receivers to form a plurality of measurements; forming an EM log from the plurality of measurements; differentiating an EM log distortion into different types of structural irregular zone comprising eccentricity, deformation, localized corrosion, and/or a combination thereof by utilizing a spectral analysis on the EM log; and determining the structural irregular zone type and severity qualitatively with magnitude and orientation of the EM log distortion.

Statement 2. The method of statement 1, wherein the EM log comprises at least one receiver's data at multiple frequencies, multiple receivers' data at a single frequency, or multiple receivers' data at multiple frequencies.

Statement 3. The method of statement 2, further comprising applying depth alignment for multiple receivers.

Statement 4. The method of statement 3, further comprising applying baseline removal for multiple receivers.

Statement 5. The method of statement 1, further comprising performing a radial one dimensional inversion, data mapping to the EM log, or a machine learning based method to acquire the structural irregular zone type and severity quantitatively.

Statement 6. The method of statement 5, wherein the data mapping comprises: building a database for different severity of different types of deformation for different signals; and mapping the signal in the database to find the best severity of the deformation.

Statement 7. The method of statement 1, wherein the one or more receivers are placed at different spacings away from the one or more transmitters to achieve different depths of penetration.

Statement 8. The method of statement 1, wherein the structural irregular zone type is caused by a collapse, dent, burst, or ridges.

Statement 9. The method of statement 1, wherein the EM log distortion is an increase or decrease in the second EM field generated by the eddy current in the two or more nested pipes

Statement 10. The method of statement 1, wherein the spectral analysis on the EM log is applied on the whole log or in a sliding window.

Statement 11. A system comprising: an electromagnetic (EM) logging tool disposed in a wellbore, wherein the EM logging tool comprises: one or more transmitters disposed on the EM logging tool configured for transmitting a first EM field from the one or more transmitters into two or more nested pipes to energize the two or more nested pipes with the first EM field thereby producing an eddy current in the one or more nested pipes; and one or more receivers disposed on the EM logging tool configured for measuring a second EM field generated by the eddy current in the two or more nested pipes with the one or more receivers to form a plurality of measurements; and an information handling system configured for: forming an EM log from the plurality of measurements; differentiating an EM log distortion into different types of structural irregular zone comprising eccentricity, deformation, localized corrosion, and/or a combination thereof by utilizing a spectral analysis on the EM log; and determining the structural irregular zone type and severity qualitatively with magnitude and orientation of the EM log distortion.

Statement 12. The system of statement 11, wherein the EM log comprises at least one receiver's data at multiple frequencies, multiple receivers' data at a single frequency, or multiple receivers' data at multiple frequencies.

Statement 13. The system of statement 12, wherein the information handling system is further configured for applying depth alignment for multiple receivers.

Statement 14. The system of statement 13, wherein the information handling system is further configured for applying baseline removal for multiple receivers.

Statement 15. The system of statement 11, wherein the information handling system is further configured for performing a radial one dimensional inversion, data mapping to the EM log, or a machine learning based method to acquire the structural irregular zone type and severity quantitatively.

Statement 16. The system of statement 15, wherein the data mapping comprises: building a database for different severity of different types of deformation for different signals; and mapping the signal in the database to find the best severity of the deformation.

Statement 17. The system of statement 11, wherein the one or more receivers are placed at different spacings away from the one or more transmitters to achieve different depths of penetration.

Statement 18. The system of statement 11, wherein the structural irregular zone type is caused by a collapse, dent, burst, or ridges.

Statement 19. The system of statement 11, wherein the EM log distortion is an increase or decrease in the second EM field generated by the eddy current in the two or more nested pipes.

Statement 20. The system of statement 11, wherein the spectral analysis on the EM log is applied on the whole log or in a sliding window.

The preceding description provides various examples of the systems and methods of use disclosed herein which may contain different method steps and alternative combinations of components. It should be understood that, although individual examples may be discussed herein, the present disclosure covers all combinations of the disclosed examples, including, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing an electromagnetic (EM) logging tool in a wellbore, wherein the EM logging tool comprises:
one or more transmitters disposed on the EM logging tool; and
one or more receivers disposed on the EM logging tool;
transmitting a first EM field from the one or more transmitters into two or more nested pipes to energize the two or more nested pipes with the first EM field thereby producing an eddy current in the one or more nested pipes;
measuring a second EM field generated by the eddy current in the two or more nested pipes with the one or more receivers to form a plurality of measurements;
forming an EM log from the plurality of measurements;
differentiating an EM log distortion into different types of structural irregular zone comprising eccentricity, deformation, localized corrosion, and/or a combination thereof by utilizing a spectral analysis on the EM log; and
determining the structural irregular zone type and severity qualitatively with magnitude and orientation of the EM log distortion.

2. The method of claim 1, wherein the EM log comprises at least one receiver's data at multiple frequencies, multiple receivers' data at a single frequency, or multiple receivers' data at multiple frequencies.

3. The method of claim 2, further comprising applying depth alignment for multiple receivers.

4. The method of claim 3, further comprising applying baseline removal for multiple receivers.

5. The method of claim 1, further comprising performing a radial one dimensional inversion, data mapping to the EM log, or a machine learning based method to acquire the structural irregular zone type and severity quantitatively.

6. The method of claim 5, wherein the data mapping comprises:
building a database for different severity of different types of deformation for different signals; and
mapping the signal in the database to find the best severity of the deformation.

7. The method of claim 1, wherein the one or more receivers are placed at different spacings away from the one or more transmitters to achieve different depths of penetration.

8. The method of claim 1, wherein the structural irregular zone type is caused by a collapse, dent, burst, or ridges.

9. The method of claim 1, wherein the EM log distortion is an increase or decrease in the second EM field generated by the eddy current in the two or more nested pipes.

10. The method of claim 1, wherein the spectral analysis on the EM log is applied on the whole log or in a sliding window.

11. A system comprising:
an electromagnetic (EM) logging tool disposed in a wellbore, wherein the EM logging tool comprises:
one or more transmitters disposed on the EM logging tool configured for transmitting a first EM field from the one or more transmitters into two or more nested pipes to energize the two or more nested pipes with the first EM field thereby producing an eddy current in the one or more nested pipes; and
one or more receivers disposed on the EM logging tool configured for measuring a second EM field generated by the eddy current in the two or more nested pipes with the one or more receivers to form a plurality of measurements; and
an information handling system configured for:
forming an EM log from the plurality of measurements;
differentiating an EM log distortion into different types of structural irregular zone comprising eccentricity, deformation, localized corrosion, and/or a combination thereof by utilizing a spectral analysis on the EM log; and
determining the structural irregular zone type and severity qualitatively with magnitude and orientation of the EM log distortion.

12. The system of claim 11, wherein the EM log comprises at least one receiver's data at multiple frequencies, multiple receivers' data at a single frequency, or multiple receivers' data at multiple frequencies.

13. The system of claim 12, wherein the information handling system is further configured for applying depth alignment for multiple receivers.

14. The system of claim 13, wherein the information handling system is further configured for applying baseline removal for multiple receivers.

15. The system of claim 11, wherein the information handling system is further configured for performing a radial one dimensional inversion, data mapping to the EM log, or a machine learning based method to acquire the structural irregular zone type and severity quantitatively.

16. The system of claim 15, wherein the data mapping comprises:
building a database for different severity of different types of deformation for different signals; and
mapping the signal in the database to find the best severity of the deformation.

17. The system of claim 11, wherein the one or more receivers are placed at different spacings away from the one or more transmitters to achieve different depths of penetration.

18. The system of claim 11, wherein the structural irregular zone type is caused by a collapse, dent, burst, or ridges.

19. The system of claim 11, wherein the EM log distortion is an increase or decrease in the second EM field generated by the eddy current in the two or more nested pipes.

20. The system of claim 11, wherein the spectral analysis on the EM log is applied on the whole log or in a sliding window.
